(19) United States
(12) Patent Application Publication
(10) Pub. No.: US 2018/0257693 A1
(43) Pub. Date: Sep. 13, 2018

(54) CLAMPING DEVICE OF AN ADJUSTABLE STEERING COLUMN FOR MOTOR VEHICLES

(71) Applicants: THYSSENKRUPP PRESTA AG, Eschen (LI); thyssenkrupp AG, Essen (DE)

(72) Inventors: Hieronymus SCHNITZER, Gamprin (LI); Ciprian PALTINISANU, Feldkirch (AT)

(73) Assignees: THYSSENKRUPP PRESTA AG, Eschen (LI); thyssenkrupp AG, Essen (DE)

(21) Appl. No.: 15/754,106

(22) PCT Filed: Aug. 17, 2016
(86) PCT No.: PCT/EP2016/069507

§ 371 Date: Feb. 21, 2018

(30) Foreign Application Priority Data
Aug. 26, 2015 (DE) 10 2015 216 348.2

(51) Int. Cl. B62D 1/184

(52) U.S. Cl. CPC B62D 1/184

(57) ABSTRACT

A clamping device may include two clamping jaws that surround an outer casing of a steering column. The clamping jaws may selectively clamp the outer casing, which receives a steering spindle. A clamp bolt may connect the clamping jaws, and an end portion of the clamp bolt may be connected to an actuating lever. When the actuating lever rotates one way, the two clamping jaws clamp the outer casing. When the actuating lever rotates the other way, the clamping jaws release the outer casing for adjustment of the steering column. The end portion of the clamp bolt may be a disk-shaped bolt head. An end region of the actuating lever connected to the clamp bolt may have a stepped passage opening with an inner portion that receives the clamp bolt and an outer portion that receives the disk-shaped bolt head.

The invention relates to a clamping device of an adjustable steering column for motor vehicles, where a bracket, which is fixedly connected to the vehicle chassis, is connected to two clamping jaws, which surround an outer casing of the steering column and between which the outer casing of the steering column, which receives a steering spindle, is clampable, having a clamp bolt which connects the two clamping jaws and which is connected at its one end portion to an actuating lever, which is rotatable about the bolt axis and interacts with a closing device which is arranged on at least one clamping jaw in such a manner that when the actuating lever is rotated in the closing direction about the bolt axis, the two clamping jaws clamp the outer casing securely and that when the actuating lever is rotated counter the closing direction, the clamping jaws release the outer casing for the adjustment of the steering column.

The invention is consequently concerned with a clamping device which changes between an open and a closed position as a result of actuating the clamping lever. In the open position, a clamp bolt is moved along the slots of a console in order, as a result, to enable longitudinal or vertical adjustment of the steering column. In the closed position, the clamp bolt is pre-tensioned and, as a result, the steering column is retained.

DE 10 2010 000 504 B3 discloses a clamping device where the clamp bolt is connected to the actuating lever by the clamp bolt comprising a toothing, onto which the actuating lever, produced from plastics material, is pressed in a joint region such that the toothing portions are embedded into the joint region.

A disadvantage of said solution is that a toothing portion, which requires installation space during production when the clamp bolt protrudes behind the actuating lever, is needed for connecting the clamp bolt to the actuating lever.

In FIG. 11, DE 10 2010 000 504 B3 additionally discloses a clamping device where the clamp bolt is connected to the actuating lever by a locknut being screwed onto a thread of the clamp bolt for securing the actuating lever against axial removal from the clamp bolt. The locknut is arranged in the actuating lever in such a manner that the actuating lever has an indentation into which the locknut is countersunk.

A disadvantage of said solution is that during production of the indentation in the actuating lever, large forming radii are generated in the transition region, as a result of which it is not possible to arrange a clamping mechanism directly on the actuating lever. In addition, it is disadvantageous that the toothing portion, necessary for the connection of the clamp bolt to the actuating lever, requires an additional operating step during production and gives rise to additional costs.

It is the object of the invention to create an improved connection between clamp bolt and actuating lever which requires a smaller installation space, can be produced in a cost-efficient manner, avoids large forming radii, and is able to be realized and mounted in a simple manner.

The solution according to the invention provides that the end portion of the clamp bolt is configured as a disk-shaped bolt head, that the actuating lever comprises, on its end region connected to the clamp bolt, a stepped through-opening with an inner portion, which is intended for the passage of the clamp bolt, faces the steering column and has a small diameter, and an outer portion which is intended for receiving the disk-shaped bolt head, is remote from the steering column and has a large diameter.

Said embodiment manages without toothing on the clamp bolt and without locknut. The clamp bolt is first of all inserted by way of its other end, which is remote from the disk-shaped bolt head, into the stepped through-opening of the actuating lever, from the outside first of all through the outer portion and then through the inner portion until the bolt head is received in its entirety or predominantly by the outer portion of the through-opening of the actuating lever. As a result, the clamp bolt does not protrude or only protrudes by an insignificantly small amount on the outside of the actuating lever, remote from the steering column. As an option, additional securing elements, which prevent the actuating lever rotating in relation to the bolt head, can be arranged between bolt head and actuating lever.

In an advantageous embodiment, the bolt head is realized in a flat and circular-cylindrical manner. The space between the side facing the actuating lever and the side of the bolt head remote from the actuating lever is narrow. The bolt head comprises a larger diameter in the region of the outer portion of the actuating lever than in the region of the inner portion.

In addition, it is conceivable and possible for the bolt head to be able to accept rectangular, hexagonal, an external thread or other geometries and to form a positive locking closure with the complementary outer portion of the through-opening of the actuating lever via a press connection, weld connection or solder connection.

The bolt shank is realized in a circular cylindrical manner and is connected to the actuating lever in the region of the inner portion by way of said inner portion by means of a press connection, weld connection or solder connection. In a further advantageous configuration of the invention, a positive locking closure between clamp bolt and actuating lever can be achieved via a matching contour of the bolt shank, in the region of the inner portion of the actuating lever, and the inner portion of the actuating lever of both components. The complementary geometry can be realized as a square or hexagonal profile or can comprise an external thread which can be connected to the internal thread of the lever.

An advantageous configuration of the invention provides that the actuating lever is a sheet metal part, where the stepped through-opening is formed after the inner portion is punched as a result of half cut embossing of the outer portion. The half cut embossing enables the deforming to be limited to as small as possible a radius around the through-opening. This is, in particular, advantageous when components of the closing device are to be arranged in the direct vicinity of the through-opening.

In an advantageous configuration of the invention, the depth of the embossing reaches between 30% and 50% of the thickness of the material of the actuating lever. As a result, a particularly compact design of the clamping device can be achieved.

In a first embodiment of the invention, it is provided that the closing device is configured as a cam clamping device which is arranged on the clamp bolt between the outside of a clamping jaw and the actuating lever. Said arrangement of the closing device is particularly simple and cost-efficient to realize in the case of the clamping device according to the invention.

In a further embodiment of the invention, it is provided that the closing device is configured as a pin clamping device which is arranged on the clamp bolt between the outside of a clamping jaw and the actuating lever. The pin clamping device is also particularly advantageous to realize at this point in the case of the clamping device according to the invention.

In a further development of the named embodiment, it is recommended that the actuating lever is configured as a component of the pin clamping device by comprising preferably two pockets, which are formed at a radial spacing from the through-opening, for receiving the ends of tilt pins of the pin clamping device. The end region of the actuating lever is consequently a component of the pin clamping device such that separate production of said component is advantageously omitted.

The last-named embodiment can be improved further as a result of the measure that the actuating lever comprises an elongated breakthrough, which is arranged at a radial spacing from the through-opening and together with a projection, which is fixedly attached to the steering column and protrudes through the breakthrough, forms two stops for the actuating lever in the totally open position and totally closed position of the pin clamping device. In this way, the limiting of the rotational range of the actuating lever is ensured in a structural manner by the configuration of the actuating lever itself.

Exemplary embodiments of the invention are explained in more detail below by way of the drawings. The figures, in detail, are as follows:

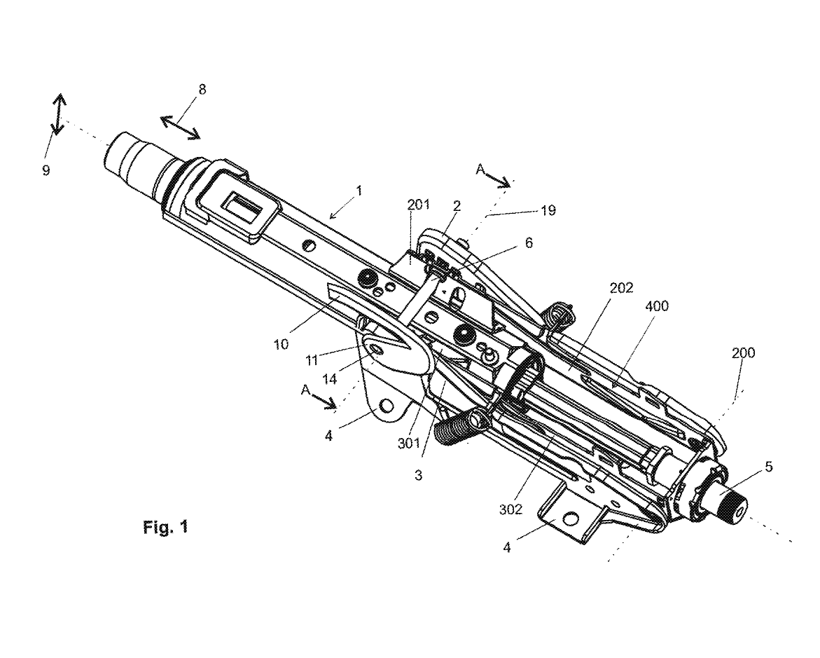

FIG. 1: shows a perspective representation of a steering column with a clamping device according to the invention;

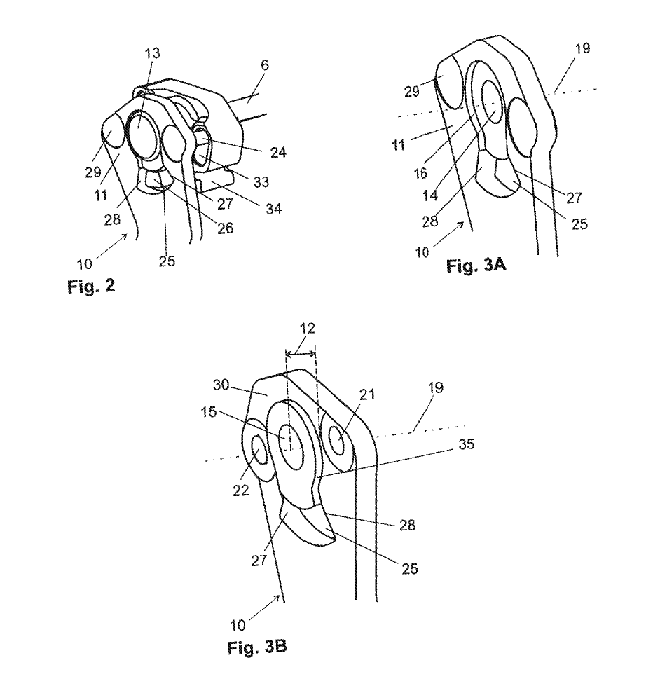

FIG. 2: shows an enlarged view of a detail of a preferred embodiment of the clamping device;

FIG. 3A: shows an enlarged partial view of an actuating lever according to the invention when seen from the outside;

FIG. 3B: shows the actuating lever of FIG. 3A when seen from the inside;

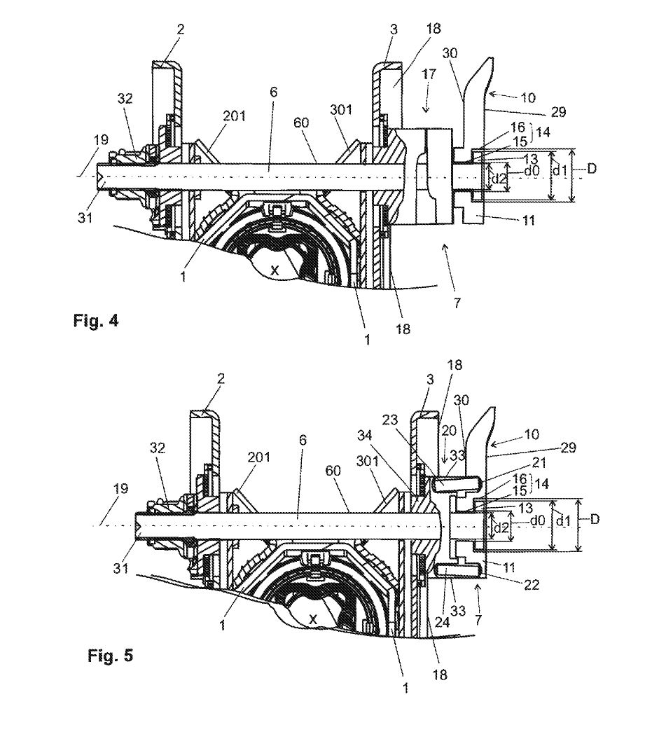

FIG. 4: shows a sectioned representation according to the line A-A from FIG. 1 in a first embodiment with a cam clamping device;

FIG. 5: shows a section, as FIG. 4, of a second embodiment with a pin clamping device.

As can be seen the best in FIG. 1, the steering column shown is fastened on the vehicle chassis (not shown) by means of a bracket 4, which also carries two clamping jaws 2, 3 which can be clamped together by means of the clamping device according to the invention. An outer casing 1, which rotatably mounts a multi-part steering spindle 5, which is movable apart and together telescopically in the axial direction 8, is clamped in this case. The outer casing 1, itself, can also be slid forward and rearward in the axial direction 8 when the clamping device is open. In addition, the outer casing 1 is able to be moved up and down in the vertical direction 9 when the clamping device is open. When the outer casing 1 is securely clamped between the clamping jaws 2, 3 by means of the clamping device according to the invention, it can be moved neither in the axial direction 8 nor the vertical direction 9.

The clamping device comprises a clamp bolt 6 which interacts with a closing device 7 in order to move the two clamping jaws 2, 3 toward one another such that said clamping jaws clamp the outer casing 1 securely between them.

As can be seen the best in FIGS. 4 and 5, the clamp bolt 6 connects the two clamping jaws 2, 3 and is connected at its one end portion 13 to an actuating lever 10 which is rotatable about the bolt axis 19. Another end 31 of the clamp bolt 6 is screw-connected to the clamping jaw 2 by means of a nut 32. The actuating lever 10 acts with the clamp bolt 6 on a closing device 7 in such a manner that when the actuating lever 10 is rotated about the bolt axis 19 in the closing direction, the two clamping jaws 2, 3 clamp the outer casing 1 securely and that when the actuating lever 10 is rotated counter the closing direction, the clamping jaws 2, 3 release the outer casing 1 for adjustment of the steering column in the axial direction 8 and in the vertical direction 9.

According to an embodiment, as shown in FIGS. 1, 4 and 5, the steering column can additionally be moved by means of a pivot lever 400 along a pivot axis 200 in the axial direction 8 and in the vertical direction 9. The pivot lever 400 comprises two side cheeks 202, 302, which are situated opposite one another and, in turn, comprise two clamping jaws 201, 301 which are situated opposite one another. The outer casing 1 is received in the pivot lever 400. The clamping jaws 201, 301 of the pivot lever 400 are located between the clamping jaws 2, 3 of the bracket 4 and are connected to the bracket 4 by the clamp bolt 6. When the actuating lever 10 is rotated in the closing direction about the bolt axis 19, the clamping jaws 2, 3 of the bracket, together with the clamping jaws 201, 301 of the pivot lever 400, clamp the outer casing 1 securely. When the actuating lever 10 is rotated counter to the closing direction, the clamping jaws 2, 201, 3, 301 release the outer casing 1 for an adjustment of the steering column in the axial direction 8 and in the vertical direction 9.

It is conceivable and possible for the clamping device to be provided with a steering column 1 which does not comprise a pivot lever 400.

The connection between the actuating lever 10 and the clamp bolt 6 is configured in such a manner that the end portion 13 of the clamp bolt 6 is realized as a disk-shaped bolt head 13 which comprises a diameter d1, and that the actuating lever 10 comprises in its end region 11 a stepped through-opening 14, through which the clamp bolt 6 projects. The stepped through-opening 14 consists of an inner portion 15 with a smaller diameter d0 and an outer portion 16 with a larger diameter D. The diameter d1 of the bolt head 13 is smaller than the diameter D of the outer portion 16 of the actuating lever 10. The clamp bolt 6 is pushed with its narrow end 31 first of all through the through-opening 14, from the outside 29 of the actuating lever 10 in the direction of the inside 30 of the actuating lever 10. Consequently, the bolt head 13 is received in its entirety in the outer portion 16 of the through-opening 14 of the actuating lever 10 such that it does not protrude beyond the outside 29 of the actuating lever 10 or only protrudes in an insignificant manner. This can also be seen equally well in FIGS. 4 and 5.

As an alternative to this, the bolt head can be realized with a circumferential contour which can be inscribed in the diameter D of the outer portion 16 of the actuating lever 10.

In the case of the embodiment shown in FIGS. 4 and 5, a connection can be formed between clamp bolt 6 and actuating lever 10 in such a manner that the diameter d2 of the bolt shank 60 in the region of the inner portion 15 comprises a circumferential contour which can be inscribed in the diameter d0 in the inner portion 15.

In the case of the embodiment of the invention shown in FIG. 4, the closing device 7 is configured as a cam clamping device 17 which is arranged on the clamp bolt 6, between the outside 18 of the clamping jaw 3 and the end region 11 of the actuating lever 10.

An even more compact and more space-saving embodiment is shown in FIG. 5. A closing device 7, which is configured as a pin clamping device 20, is arranged here between the outside 18 of the clamping jaw 3 and the end region 11 of the actuating lever 10. In this case, the end region 11 of the actuating lever 10 is itself a component of the pin clamping device 20, for two pockets 21, 22, which serve for receiving two tilt pins 23, 24 of the pin clamping device 20, are formed into the inside 30 of the actuating lever 10.

The function of the pin clamping device 20 is shown in detail in FIGS. 2, 3A and 3B. The end region 11 of the actuating lever 10 and the clamp bolt 6, the bolt head 13 of which is pushed through the actuating lever 10, can be seen in FIG. 2. In addition, it is possible to see a tilt pin 24 which projects by way of one end into the pocket 22 (not visible here) of the actuating lever 10 and the other end of which is received by a recess 33 of a clamping part 34 of the pin clamping device 20. Correspondingly, the tilt pin 23 (not visible) is also arranged in the pocket 21 (not visible) of the actuating lever 10 and its other end is arranged in a further recess (not visible) of the clamping part 34. FIG. 2 shows the pin clamping device 20 in the closed state, where the spacing between the end region 11 and the clamping part 34 is maximum. The clamping part 34, in this case, acts on the clamping jaw 3 and presses it against the outer casing 1, whereas, on the other side, the bolt head 13 is pulled outward by the end region 11 of the actuating lever 10, as a result of which the other end 31 of the clamp bolt 6 acts on the clamping jaw 2 via the nut 32 and presses it from the other side against the outer casing 1. (See FIG. 5)

The pin clamping device 20 can be opened by the actuating lever 10 being rotated in the opening direction; in FIG. 2 this would be clockwise. In this case, the tilt pins 23, 24 are tilted in their recesses 33 such that their effective length is shortened in the direction of the bolt axis 19. As a result, the end region 11 of the actuating lever 10 can move toward the clamping part 34, the clamp bolt 6 also experiencing displacement in the direction of the oppositely situated clamping jaw 2. This, in turn, allows the two clamping jaws 2, 3 to move apart in opposite directions and to release the outer casing 1 from the clamping grip.

FIGS. 3A and 3B show the forming of the end region 11 of the actuating lever 10 in detail, in particular the through-opening 14 with its narrower inner portion 15 and the wider outer portion 16 which serves for receiving the bolt head 13 of the clamp bolt 6.

The through-opening 14 is consequently in the form of a stepped bore. However, it is not generated as a result of boring, but as a result of stamping and deforming the sheet metal part which makes the actuating lever 10. In particular, the outer portion 16 is formed by means of half cut embossing (or a semi-shear process) in the sheet metal material. This occurs on the outside 29 of the actuating lever 10 remote from the steering column. On the oppositely situated inside 30 of the actuating lever 10, the sheet metal material, which has been pressed away in the outer portion 16, has to appear as a projection 35.

It is then a particular advantage of the named half cut method that the expansion of the projection 35 in the radial direction, when seen from the bolt axis 19, can be kept relatively small. This means that a radius 12 of the deformation is relatively small. This, in turn, enables the arrangement of other operating elements of the pin clamping mechanism 20, in particular of the pockets 21, 22, to be arranged close and nevertheless outside the space 12 of the bolt axis 19. This can be seen the best in FIG. 3B. The arrangement of the pockets 21, 22 close to the bolt axis 19, in turn, enables the arrangement of the tilt pins 23, 24 within the same small space range, as a result of which the clamping force available for the closing of the pin clamping mechanism 20 can be increased and the actuating force to be applied manually to the actuating lever 10 can be reduced. In short: with the tilt pins 23, 24 arranged close to the bolt axis 19, there is a small lever arm on the side of the pin clamping device 20 in comparison with the large lever arm (not shown) of the grip region of the operating lever 10.

The best results with half cut embossing are obtained when the embossing depth is between 30% and 50% of the thickness of the material of the actuating lever 10.

As can be seen the best in FIG. 2, the actuating lever 10 is additionally provided with a breakthrough 25 which is in the form of an elongated, bent slot. The breakthrough 25 is arranged at a radial spacing from the bolt axis 19 or from the center of the through-opening 14. In addition, the clamping part 34 comprises a projection 26 which is also arranged at a radial spacing from the bolt axis 19 and projects in the axial direction into the breakthrough 25 of the actuating lever 10. The projection 26 consequently delimits the rotational movement of the actuating lever 10 by knocking against the lateral walls 27, 28 of the breakthrough 25 such that the actuating lever 10 is not able to be rotated any further. An open position and a closed position of the actuating lever 10 is fixed as a result. The named lateral walls of the breakthrough 25 consequently form two stops 27, 28.

### LIST OF REFERENCES

1 Outer casing
2 Clamping jaw
3 Clamping jaw
4 Bracket
5 Steering spindle
6 Clamp bolt
7 Closing device
8 Axial direction
9 Vertical direction
10 Actuating lever
11 End region
12 Radius/spacing
13 End portion/bolt head
14 Through-opening
15 Inner portion
16 Outer portion
17 Cam clamping device
18 Outside
19 Bolt axis
20 Pin clamping device
21 Pocket
22 Pocket
23 Tilt pin
24 Tilt pin
25 Breakthrough
26 Projection
27 Wall/stop
28 Wall/stop
29 Outside
30 Inside
31 Other end
32 Nut
33 Recess
34 Clamping part
35 Projection
d0 Diameter
d1 Diameter
d2 Diameter
D Diameter
60 Bolt shank
201 Clamping jaw
301 Clamping jaw
202 Clamping bar
302 Clamping bar
200 Pivot axis
400 Pivot lever

1.-7. (canceled)

8. A clamping device for a steering column, the clamping device comprising:
clamping jaws that surround and selectively clamp an outer casing of the adjustable steering column; and
a clamp bolt that connects the clamping jaws, wherein an end portion of the clamp bolt is connected to an actuating lever, which actuating lever is rotatable such that the clamping jaws clamp the outer casing upon rotation of the actuating lever in a closing direction and such that the clamping jaws release the outer casing upon rotation of the actuating lever counter to the closing direction,
wherein an end region of the actuating lever that is connected to the clamp bolt includes a stepped through-opening with
an inner portion that receives the clamp bolt and faces the steering column, and
an outer portion that receives the end portion of the clamp bolt and is more remote from the steering column than the inner portion.

9. The clamping device of claim 8 wherein a diameter of the inner portion of the stepped through-opening is smaller than a diameter of the outer portion of the stepped through-opening.

10. A clamping device for a steering column, the clamping device comprising:
clamping jaws that surround and selectively clamp an outer casing of the adjustable steering column; and
a clamp bolt that connects the clamping jaws, wherein an end portion of the clamp bolt is connected to an actuating lever, which actuating lever is rotatable such that the clamping jaws clamp the outer casing upon rotation of the actuating lever in a closing direction and such that the clamping jaws release the outer casing upon rotation of the actuating lever counter to the closing direction,
wherein an end region of the actuating lever that is connected to the clamp bolt includes a stepped through-opening with an inner portion and an outer portion, wherein a diameter of the inner portion of the stepped through-opening is smaller than a diameter of the outer portion of the stepped through-opening.

11. The clamping device of claim 10 wherein the inner portion of the stepped through-opening receives the clamp bolt and faces the steering column.

12. The clamping device of claim 10 wherein the outer portion of the stepped through-opening receives the disk-shaped bolt head and is more remote from the steering column than the inner portion.

13. A clamping device of an adjustable steering column for a motor vehicle, the clamping device comprising:
a bracket that is connected to a vehicle chassis and to two clamping jaws that surround an outer casing of the adjustable steering column, wherein the outer casing receives a steering spindle and is configured to be clamped between the two clamping jaws; and
a clamp bolt that connects the two clamping jaws, wherein an end portion of the clamp bolt is a disk-shaped bolt head and is connected to an actuating lever, which actuating lever is rotatable about a bolt axis and interacts with a closing device that is disposed on at least one of the two clamping jaws such that when the actuating lever is rotated in a closing direction about the bolt axis the two clamping jaws clamp the outer casing and such that when the actuating lever is rotated counter to the closing direction the two clamping jaws release the outer casing for adjustment of the adjustable steering column,
wherein an end region of the actuating lever that is connected to the clamp bolt includes a stepped through-opening with
an inner portion that receives the clamp bolt, that faces the steering column, and that has a first diameter, and
an outer portion that receives the disk-shaped bolt head, that is more remote from the steering column than the inner portion, and that has a second diameter that is larger than the first diameter of the inner portion.

14. The clamping device of claim 13 wherein the actuating lever is a sheet metal part.

15. The clamping device of claim 14 wherein the stepped through-opening is formed after punching the inner portion as a result of half cut embossing the outer portion.

16. The clamping device of claim 15 wherein a depth of the half cut embossing reaches between 30% to 50% of a thickness of a material of the actuating lever.

17. The clamping device of claim 13 wherein the closing device is configured as a cam clamping device that is disposed on the clamp bolt between an outside of the at least one of the two clamping jaws and the actuating lever.

18. The clamping device of claim 13 wherein the closing device is configured as a pin clamping device that is disposed on the clamp bolt between an outside of the at least one of the two clamping jaws and the actuating lever.

19. The clamping device of claim 18 wherein the actuating lever comprises an elongated breakthrough that is disposed at a radial distance from the stepped through-opening, wherein a projection is attached to the adjustable steering column and protrudes through the elongated breakthrough, wherein the elongated breakthrough and the projection form two stops for the actuating lever in a completely-open position and a completely-closed position of the pin clamping device.

20. The clamping device of claim 18 wherein the actuating lever is a component of the pin clamping device, wherein the actuating lever comprises two pockets disposed at a radial distance from the stepped through-opening, which two pockets receive ends of tilt pins of the pin clamping device.

21. The clamping device of claim 20 wherein the actuating lever comprises an elongated breakthrough that is disposed at a radial distance from the stepped through-opening, wherein a projection is attached to the adjustable steering column and protrudes through the elongated breakthrough, wherein the elongated breakthrough and the projection form two stops for the actuating lever in a completely-open position and a completely-closed position of the pin clamping device.
